(19) United States
(12) Patent Application Publication
(10) Pub. No.: US 2026/0024809 A1
(43) Pub. Date: Jan. 22, 2026

(54) NON-AQUEOUS ELECTROLYTE SOLUTION AND LITHIUM BATTERY

(71) Applicant: ZHANGJIAGANG GUOTAI-HUARONG NEW CHEMICAL MATERIALS CO., LTD., Zhangjiagang, Suzhou (CN)

(72) Inventors: Xiaoqin Chen, Zhangjiagang, Suzhou (CN); Erbo Shi, Zhangjiagang, Suzhou (CN); Chaolun Gan, Zhangjiagang, Suzhou (CN); Xiaofeng Lu, Zhangjiagang, Suzhou (CN); Li Zhang, Zhangjiagang, Suzhou (CN)

(73) Assignee: ZHANGJIAGANG GUOTAI-HUARONG NEW CHEMICAL MATERIALS CO., LTD., Zhangjiagang, Suzhou (CN)

(21) Appl. No.: 18/875,307

(22) PCT Filed: May 30, 2023
(86) PCT No.: PCT/CN2023/097061

§ 371 Date: Dec. 16, 2024

(30) Foreign Application Priority Data
Jun. 16, 2022 (CN) 202210683810.6

(51) Int. Cl. H01M 10/0567; H01M 4/525; H01M 4/583; H01M 10/052; H01M 10/0568; H01M 10/0569

(52) U.S. Cl. CPC H01M 10/0567; H01M 4/525; H01M 4/583; H01M 10/052; H01M 10/0568; H01M 10/0569; H01M 2300/0037

(57) ABSTRACT

Embodiments described herein are directed to an electrolyte solution and a lithium-ion secondary battery. The electrolyte solution includes an organic solvent, an electrolyte salt and an additive, wherein the additive includes pyridine boron trifluoride, fluoroethylene carbonate and 1,3,6-hexanetricarbonitrile. The mass percentage content of the pyridine boron trifluoride in the electrolyte solution is 0.1-5%; the mass percentage content of the fluoroethylene carbonate in the electrolyte solution is 0.1-8%; and the mass percentage content of the 1,3,6-hexanetricarbonitrile in the electrolyte solution is 0.1-5%. By means of the synergistic effect of the different types of additives mentioned above, the high-temperature performance and the normal-temperature performance of a high-voltage lithium-ion battery are improved; moreover, the use of sulfur-containing substances can be reduced or even avoided.

### CROSS REFERENCE TO RELATED APPLICATIONS

The present application is a U.S. National Stage Application of International Application Number PCT/CN2023/097061 filed May 30, 2023, which claims priority to Chinese Patent Application No. 202210683810.6, filed Jun. 16, 2022, the disclosures of which are both hereby incorporated by reference herein in their entireties.

### TECHNICAL FIELD

The present disclosure relates to the technical field of lithium-ion batteries and, in particular, to a non-aqueous electrolyte and a lithium battery.

### BACKGROUND

With the advent of emerging consumer areas such as mobile phones, tablet PCs, smart wearables, and ETC, lithium-ion batteries have shown great advantages with their high energy density and long cycle life. However, as the functions of corresponding devices are continuously diversified and power consumption of power modules increases continuously, the needs of users have been hardly met by conventional lithium-ion batteries. To improve the user experience, it has become increasingly clear that the development direction of lithium-ion batteries is to safely increase energy density as much as possible or achieve fast charging. To improve energy density, the industry is developed currently in three main aspects. The first is to seek new material systems, such as lithium cobalt oxide, lithium-rich manganese-based, ternary high-nickel cathode materials and silicon carbon anode materials. The second is to increase the charge cut-off voltage of existing materials, such as lithium cobalt oxide batteries with a voltage of 4.4V or above and ternary batteries with a voltage of 4.4V or above. The third is to increase the surface density and compaction density or use thinner current collectors, tapes, aluminum plastic shells or the like by changing the battery process. On the other hand, to shorten the charging time and reach the rated power, fast-charging lithium-ion batteries came into being, from the initial 0.2 C charging, to the later 2 C charging, and even 5 C charging.

In the digital field with high requirements for volume energy density, the design idea of lithium batteries is to use high-voltage lithium cobalt oxide & silicon-carbon anodes, and the voltage of commercial lithium cobalt oxide batteries has been gradually increased from the original 4.2V to 4.48V. However, the chemical window of the non-aqueous organic electrolyte currently used is usually lower than 4.4V. When the charge cut-off voltage is higher than 4.4V, the electrolyte will undergo oxidation and decomposition on the surface of the battery. This process causes the battery capacity to decrease sharply. In the meanwhile, the products of oxidation and decomposition cover the surface of the electrode material, causing the battery to have an increased internal resistance. Moreover, as the SVHC (substances of very high concern) list becomes wider and wider, many sulfur-containing compounds may be restricted subsequently. Therefore, it is desired to develop an electrolyte that does not contain sulfur and has good high-temperature and cycle performance at a high voltage.

### SUMMARY OF THE INVENTION

An objective of the present disclosure is to provide a non-aqueous electrolyte that can improve the high-temperature performance and cycle performance of lithium batteries at a high voltage.

Another objective of the present disclosure is to provide a lithium battery comprising an non-aqueous electrolyte.

To solve the above technical problems, the present disclosure adopts the following technical solutions:

In a first aspect of the present disclosure, provided is a non-aqueous electrolyte, comprising an organic solvent, an electrolyte lithium salt and additives, wherein the additives include pyridine boron trifluoride, fluoroethylene carbonate, and hexane-1,3,6-tricarbonitrile. The mass percentage content of the pyridine boron trifluoride in the non-aqueous electrolyte is 0.1%-5%. The mass percentage content of the fluoroethylene carbonate in the non-aqueous electrolyte is 0.1%-10%. The mass percentage content of the hexane-1,3,6-tricarbonitrile in the non-aqueous electrolyte is 0.1%-5%.

In the present application, the pyridine boron trifluoride has a structural formula of:

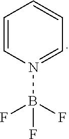

Further, the additives further include succinonitrile, and the mass percentage content of the succinonitrile in the non-aqueous electrolyte is 0.1%-5%.

Further, the mass percentage content of the succinonitrile in the non-aqueous electrolyte is 1%-4%.

Further, the mass percentage content of the succinonitrile in the non-aqueous electrolyte is 1%-3%.

Further, the mass percentage content of the hexane-1,3,6-tricarbonitrile in the non-aqueous electrolyte is 1%-5%.

Further, the mass percentage content of the hexane-1,3,6-tricarbonitrile in the non-aqueous electrolyte is 1%-4%.

Further, the mass percentage content of the hexane-1,3,6-tricarbonitrile in the non-aqueous electrolyte is 2%-4%.

Further, the mass percentage content of the pyridine boron trifluoride in the non-aqueous electrolyte is 0.1%-2%.

Further, the mass percentage content of the pyridine boron trifluoride in the non-aqueous electrolyte is 0.1%-1%.

More further, the mass percentage content of the pyridine boron trifluoride in the non-aqueous electrolyte is 0.5%-1%.

Further, the mass percentage content of the fluoroethylene carbonate in the non-aqueous electrolyte is 1%-10%.

Further, the mass percentage content of the fluoroethylene carbonate in the non-aqueous electrolyte is 2%-8%.

Further, the non-aqueous electrolyte further comprises other additives, and the other additives include one or more of vinyl ethylene carbonate, tris(trimethylsilyl)borate, tris(trimethylsilyl)phosphate, adiponitrile, 1,2-bis(2-cyanoethoxy)ethane, 1,4-dicyano-2-butene, 1,2,3-tris(2-cyanoethoxy)propane, lithium tetrafluoroborate, and sebaconitrile, and the mass percentage content of each of the other additives in the non-aqueous electrolyte is 0.1%-5%. The content of each of the other additives is defined as follows: when the non-aqueous electrolyte only comprises one of the other additives described above, the mass percentage content of the other additive is 0.1%-5%; when the non-aqueous electrolyte only comprises two of the other additives described above, the mass percentage content of each of the two additives is 0.1%-5%; when the non-aqueous electrolyte comprises three or more of the other additives described above, the mass percentage content of each of the three or more additives is 0.1%-5%.

Further, the mass percentage content of each of the other additives in the non-aqueous electrolyte is 0.1%-1%.

Further, the non-aqueous electrolyte does not comprise lithium difluoro(oxalato)borate.

Further, the non-aqueous electrolyte does not comprise sulfur-containing compounds.

Further, the organic solvent is a mixture of a cyclic ester and a chain ester, and the cyclic ester includes one or more of γ-butyrolactone, ethylene carbonate, and propylene carbonate. The chain ester includes one or more of dimethyl carbonate, ethyl methyl carbonate, diethyl carbonate, methylpropyl carbonate, methyl propionate, ethyl propionate, propyl propionate, methyl acetate, ethyl acetate, propyl acetate, methyl butyrate, ethyl butyrate, propyl butyrate, methyl fluoropropionate, ethyl fluoropropionate, and ethyl fluoroacetate.

Further, the lithium salt includes one or more of lithium hexafluorophosphate, lithium hexafluoroarsenate, anhydrous lithium perchlorate, lithium bis(trifluoromethylsulfonyl)imide, lithium difluorophosphate, lithium trifluoromethylsulfonate, and lithium bis(fluorosulfonyl)imide.

Further, the concentration of the lithium salt is 0.8-3 mol/L.

Further, the concentration of the lithium salt is 0.8-1.5 mol/L.

In a second aspect of the present disclosure, provided is a high-voltage lithium battery, comprising a cathode, an anode and an electrolyte, wherein the electrolyte is the non-aqueous electrolyte.

Further, the charge cut-off voltage of the lithium battery is higher than 4.4V, for example, the charge cut-off voltage of the lithium battery is 4.55V or even higher.

Further, the charge cut-off voltage of the lithium battery may be as high as 4.55V.

Further, the charge cut-off voltage of the lithium battery is higher than 4.4V, and is 4.55V and below.

According to some embodiments, the lithium battery is a lithium cobalt oxide graphite battery.

Compared with the prior art, the present disclosure has the following advantages:

By using the combination of different types of additives, especially pyridine boron trifluoride, fluoroethylene carbonate, and hexane-1,3,6-tricarbonitrile, to produce synergistic coordination, the present disclosure ensures the high-temperature performance and cycle performance of lithium batteries at a conventional voltage; in addition, when the voltage is increased to 4.55V or even higher, the catalytic decomposition of carbonate solvents at a high voltage can be inhibited and the gas production of the batteries and the dissolution of metal ions can also be inhibited, so that lithium batteries achieves better high-temperature performance and cycle performance, as well as better safety performance and electrochemical performance. Moreover, the present disclosure also gives attention to the high-temperature performance and room-temperature performance of lithium-ion batteries at a high voltage. Moreover, the use of sulfur-containing substances in the non-aqueous electrolyte can be reduced or even avoided.

### DETAILED DESCRIPTION OF PREFERRED EMBODIMENTS

The disclosure is further described below in conjunction with embodiments. However, the disclosure is not limited to the following embodiments. The implementation conditions used in the embodiments may be further adjusted according to the different requirements of specific use, and the implementation conditions not specified are conventional conditions in this industry. The technical features involved in various embodiments of the disclosure may be combined with each other as long as they do not conflict with each other.

As the voltage of lithium batteries gradually increases, it brings certain negative effects. For example, the reaction activity of the material surface is significantly higher than that of the bulk phase due to the presence of dangling bonds and unsaturated coordination relationships. During a process of charging a lithium cobalt oxide battery, the following reaction process occurs: (1) a cathode material begins to delithiate from the surface; (2) after delithiation occurs, oxygen atoms in a Li layer lose their barrier and repel each other, resulting in an unstable surface structure; (3) continuous delithiation promotes the surface lattice activity to cause gas overflow; (4) the overflowing gas causes the surface Co atoms to become less stable and dissolved; (5) the dissolved high-valent Co element will also oxidize the electrolyte and participate in the chemical reaction of the electrolyte. Side reactions at the solid-liquid interface are an inevitable problem in the development of lithium batteries. The chemical window of the non-aqueous organic electrolyte currently used is usually lower than 4.4V. When the charge cut-off voltage is higher than 4.4V, the electrolyte will undergo oxidation and decomposition on the surface of the battery. This process causes the battery capacity to decrease sharply. In the meanwhile, the products of oxidation and decomposition cover the surface of the electrode material, causing the battery to have an increased internal resistance. Free transition metal elements catalyze the demarcation of surface side reaction products, so that the electrode material maintains a high activity state, thereby posing hidden dangers.

As the SVHC list becomes wider and wider, many sulfur-containing compounds may be restricted subsequently. Therefore, after in-depth research and a large number of experiments, the inventors of the present disclosure finally provide an electrolyte that does not contain sulfur and has good high-temperature and cycle performance at a high voltage.

In the present disclosure, by adding additives (pyridine boron trifluoride, fluoroethylene carbonate, and hexane-1,3,6-tricarbonitrile), and optionally adding succinonitrile and other additives to produce synergistic coordination in combination with other components in the non-aqueous electrolyte, the high-temperature performance and cycle performance of lithium batteries at a conventional voltage are ensured; in addition, when the voltage is increased to 4.55V or even higher, the lithium batteries can ensure the cycle stability at room temperature and can be inhibited from swelling, cyclic attenuation and thickness increase at a high temperature. As a result, the lithium batteries achieve better high-temperature performance and cycle performance, as well as better safety performance and electrochemical performance.

The disclosure is further described below in conjunction with embodiments. However, the disclosure is not limited to the following embodiments. The implementation conditions used in the embodiments may be further adjusted according to the different requirements of specific use, and the implementation conditions not specified are conventional conditions in this industry. The technical features involved in various embodiments of the disclosure may be combined with each other as long as they do not conflict with each other. In the specific embodiments of the present disclosure, the raw materials used can be obtained commercially.

### Example 1

In an argon-filled glove box (H₂O content <10 ppm), diethyl carbonate (DEC), ethylene carbonate (EC), propylene carbonate (PC), ethyl propionate (EP) and propyl propionate (PP) were mixed homogeneously in a volume ratio of 1:2:1:3:3 to obtain a mixed solution, 1.15 mol/L LiPF₆ was added to the mixed solution to obtain an electrolyte, and then 4 wt % of fluoroethylene carbonate, 5 wt % of hexane-1,3,6-tricarbonitrile and 0.5 wt % of pyridine boron trifluoride were separately added to the electrolyte, thus obtaining a final electrolyte.

### Example 2

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 0.1 wt % of pyridine boron trifluoride were separately added to the electrolyte, thus obtaining a final electrolyte.

### Example 3

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 0.5 wt % of pyridine boron trifluoride were separately added to the electrolyte, thus obtaining a final electrolyte.

### Example 4

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 1 wt % of pyridine boron trifluoride were separately added to the electrolyte, thus obtaining a final electrolyte.

### Example 5

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 2 wt % of pyridine boron trifluoride were separately added to the electrolyte, thus obtaining a final electrolyte.

### Example 6

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 1 wt % of fluoroethylene carbonate, 3 wt % of hexane-1,3,6-tricarbonitrile and 0.5 wt % of pyridine boron trifluoride were separately added to the electrolyte, thus obtaining a final electrolyte.

### Example 7

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 2 wt % of fluoroethylene carbonate, 3 wt % of hexane-1,3,6-tricarbonitrile and 0.5 wt % of pyridine boron trifluoride were separately added to the electrolyte, thus obtaining a final electrolyte.

### Example 8

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 8 wt % of fluoroethylene carbonate, 3 wt % of hexane-1,3,6-tricarbonitrile and 0.5 wt % of pyridine boron trifluoride were separately added to the electrolyte, thus obtaining a final electrolyte.

### Example 9

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 10 wt % of fluoroethylene carbonate, 3 wt % of hexane-1,3,6-tricarbonitrile and 0.5 wt % of pyridine boron trifluoride were separately added to the electrolyte, thus obtaining a final electrolyte.

### Example 10

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 2 wt % of fluoroethylene carbonate, 3 wt % of hexane-1,3,6-tricarbonitrile and 1 wt % of pyridine boron trifluoride were separately added to the electrolyte, thus obtaining a final electrolyte.

### Example 11

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile, 0.5 wt % of tris(trimethylsilyl)borate and 0.5 wt % of pyridine boron trifluoride were separately added to the electrolyte, thus obtaining a final electrolyte.

### Example 12

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile, 0.5 wt % of tris(trimethylsilyl)phosphate and 0.5 wt % of pyridine boron trifluoride were separately added to the electrolyte, thus obtaining a final electrolyte.

### Example 13

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile, 0.5 wt % of lithium tetrafluoroborate and 0.5 wt % of pyridine boron trifluoride were separately added to the electrolyte, thus obtaining a final electrolyte.

### Example 14

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile, 0.5 wt % of lithium difluoro(oxalato)borate and 0.5 wt % of pyridine boron trifluoride were separately added to the electrolyte, thus obtaining a final electrolyte.

### Example 15

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile, 0.5 wt % of pyridine boron trifluoride and 0.8 wt % of 1,3-propane sultone were separately added to the electrolyte, thus obtaining a final electrolyte.

### Comparative Example 1

In an argon-filled glove box (H₂O content <10 ppm), DEC, EC, PC, EP and PP were mixed homogeneously in a volume ratio of 1:2:1:3:3 to obtain a mixed solution, and 1.15 mol/L LiPF₆ was added to the mixed solution, thus obtaining an electrolyte.

### Comparative Example 2

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile was added to the electrolyte, thus obtaining a final electrolyte.

### Comparative Example 3

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile and 4 wt % of fluoroethylene carbonate were separately added to the electrolyte, thus obtaining a final electrolyte.

### Comparative Example 4

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate and 3 wt % of hexane-1,3,6-tricarbonitrile were separately added to the electrolyte, thus obtaining a final electrolyte.

### Comparative Example 5

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 0.5 wt % of lithium difluoro(oxalato)borate were separately added to the electrolyte, thus obtaining a final electrolyte.

### Comparative Example 6

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 0.8 wt % of 1,3-propane sultone were separately added to the electrolyte, thus obtaining a final electrolyte.

### Comparative Example 7

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 1 wt % of 1,3-propane sultone were separately added to the electrolyte, thus obtaining a final electrolyte.

### Comparative Example 8

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 2 wt % of 1,3-propane sultone were separately added to the electrolyte, thus obtaining a final electrolyte.

### Comparative Example 9

In an argon-filled glove box (H₂O content <10 ppm), DEC, EC, PC, EP and PP were mixed homogeneously in a volume ratio of 1:2:1:3:3 to obtain a mixed solution, 1.15 mol/L LiPF₆ was added to the mixed solution to obtain an electrolyte, and then 2 wt % of succinonitrile, 4 wt % of fluoroethylene carbonate, 3 wt % of hexane-1,3,6-tricarbonitrile and 4 wt % of 1,3-propane sultone were separately added to the electrolyte, thus obtaining a final electrolyte.

The electrolytes prepared in the above examples and comparative examples were separately assembled into lithium cobalt oxide graphite batteries. The above lithium cobalt oxide graphite batteries were tested respectively for capacity retention and battery swelling after high-temperature storage at 85° C. for 4 h. The test data are shown in Table 1. The test was performed as follows: the batteries were charged to 4.55V at 25° C., 1 C under constant current/constant voltage (CC/CV), and then stored in an oven at 85° C. for 4 h, and then respectively discharged to 3.0V at 1 C to test the capacity and thickness after high-temperature storage at 85° C. for 4 h; and these batteries also were tested for capacity and thickness after being charged under the same conditions and then discharged under the same conditions without being stored at a high temperature. The capacity retention of the above batteries after high-temperature storage at 85° C. for 4 h is equal to the capacity after high-temperature storage at 85° C. for 4 h divided by the capacity without high-temperature storage. The battery swelling of the above batteries after high-temperature storage at 85° C. for 4 h is equal to the difference between the battery thickness after storage and the battery thickness before storage divided by the battery thickness before storage. The above lithium cobalt oxide graphite batteries were tested respectively for the capacity retention after 200 cycles at 45° C. and the DCR at 50% SOC, 2 C for 10 s. The test for the capacity retention after 200 cycles at 45° C. was performed as follows: the batteries were charged to 4.55V at 45° C., 1 C under constant current/constant voltage (CC/CV) and then discharged to 3.0V at 1 C to test the battery capacity after the first charge and discharge and the battery capacity after 200 cycles of charge and discharge. The capacity retention after 200 cycles at 45° C. is equal to the battery capacity after 200 cycles of charge and discharge divided by the battery capacity after the first charge and discharge. The test for the DCR at 50% SOC, 2 C for 10 s was performed as follows: the batteries were tested at the ratio of voltage difference to current when discharged at 50% SOC, 2 C (constant current) for 10 s. The relevant experimental data are shown in Table 1.

TABLE 1

| | | Capacity | Battery | | |
|---|---|---|---|---|---|
| | | retention (%) | swelling (%) | Capacity | |
| | | after high- | after high- | retention (%) | |
| | | temperature | temperature | after 200 | |
| | | storage at 85° | storage at 85° | cycles at | DCR |
| | Additive | C. for 4 h | C. for 4 h | 45° C. | (mΩ) |
| Example 1 | Fluoroethylene carbonate 4 wt %, | 91.0 | 9.5 | 90.7 | 29.3 |
| | hexane-1,3,6-tricarbonitrile 5 wt %, | | | | |
| | pyridine boron trifluoride | | | | |
| Example 2 | Succinonitrile 2 wt %, | 90.1 | 5.2 | 91.5 | 24.1 |
| | fluoroethylene carbonate 4 wt %, | | | | |
| | hexane-1,3,6-tricarbonitrile 3 wt %, | | | | |
| | pyridine boron trifluoride | | | | |
| Example 3 | Succinonitrile 2 wt %, | 92.3 | 5.1 | 92.6 | 24.2 |
| | fluoroethylene carbonate 4 wt %, | | | | |
| | hexane-1,3,6-tricarbonitrile 3 wt %, | | | | |
| | pyridine boron trifluoride | | | | |
| Example 4 | Succinonitrile 2 wt %, | 92.9 | 5.3 | 92.4 | 24.3 |
| | fluoroethylene carbonate 4 wt %, | | | | |
| | hexane-1,3,6-tricarbonitrile 3 wt %, | | | | |
| | pyridine boron trifluoride | | | | |
| Example 5 | Succinonitrile 2 wt %, | 89.8 | 7.8 | 90.5 | 25.4 |
| | fluoroethylene carbonate 4 wt %, | | | | |
| | hexane-1,3,6-tricarbonitrile 3 wt %, | | | | |
| | pyridine boron trifluoride | | | | |
| Example 6 | Succinonitrile 2 wt %, | 89.5 | 9.8 | 86.5 | 26.4 |
| | fluoroethylene carbonate 1 wt %, | | | | |
| | hexane-1,3,6-tricarbonitrile 3 wt %, | | | | |
| | pyridine boron trifluoride | | | | |
| Example 7 | Succinonitrile 2 wt %, | 90.2 | 6.8 | 89.4 | 25.7 |
| | fluoroethylene carbonate 2 wt %, | | | | |
| | hexane-1,3,6-tricarbonitrile 3 wt %, | | | | |
| | pyridine boron trifluoride 0.5 wt % | | | | |
| Example 8 | Succinonitrile 2 wt %, | 90.8 | 7.6 | 90.4 | 26.9 |
| | fluoroethylene carbonate 8 wt %, | | | | |
| | hexane-1,3,6-tricarbonitrile 3 wt %, | | | | |
| | pyridine boron trifluoride | | | | |
| Example 9 | Succinonitrile 2 wt %, | 90.4 | 8.6 | 89.9 | 27.5 |
| | fluoroethylene carbonate 10 wt %, | | | | |
| | hexane-1,3,6-tricarbonitrile 3 wt %, | | | | |
| | pyridine boron trifluoride | | | | |
| Example 10 | Succinonitrile 2 wt %, | 92.8 | 5.4 | 93.1 | 24.5 |
| | fluoroethylene carbonate 2 wt %, | | | | |
| | hexane-1,3,6-tricarbonitrile 3 wt %, | | | | |
| | pyridine boron trifluoride | | | | |
| Example 11 | Succinonitrile 2 wt %, | 92.4 | 5.0 | 92.7 | 24.2 |
| | fluoroethylene carbonate 4 wt %, | | | | |
| | hexane-1,3,6-tricarbonitrile 3 wt %, | | | | |
| | tris(trimethylsilyl)borate 0.5 wt %, | | | | |
| | pyridine boron trifluoride 0.5 wt % | | | | |
| Example 12 | Succinonitrile 2 wt %, | 92.6 | 4.8 | 92.8 | 24.3 |
| | fluoroethylene carbonate 4 wt %, | | | | |
| | hexane-1,3,6-tricarbonitrile 3 wt %, | | | | |
| | tris(trimethylsilyl)phosphate | | | | |
| Example 13 | Succinonitrile 2 wt %, | 92.5 | 4.7 | 92.4 | 24.2 |
| | fluoroethylene carbonate 4 wt %, | | | | |
| | hexane-1,3,6-tricarbonitrile 3 wt %, | | | | |
| | lithium tetrafluoroborate 0.5 wt %, | | | | |
| Example 14 | Succinonitrile 2 wt %, | 86.6 | 16.3 | 88.5 | 26.5 |
| | fluoroethylene carbonate 4 wt %, | | | | |
| | hexane-1,3,6-tricarbonitrile 3 wt %, | | | | |
| | lithium difluoro(oxalato)borate 0.5 wt %, | | | | |
| | pyridine boron trifluoride 0.5 wt % | | | | |
| Example 15 | Succinonitrile 2 wt %, | 89.8 | 8.8 | 90.5 | 25.3 |
| | fluoroethylene carbonate 4 wt %, | | | | |
| | hexane-1,3,6-tricarbonitrile 3 wt %, | | | | |
| | 1,3-propane sultone 0.8 wt %, | | | | |
| | pyridine boron trifluoride 0.5 wt % | | | | |
| Comparative | / | 50.5 | 22.2 | 45.3 | 45.7 |
| Example 1 | | | | | |
| Comparative | Succinonitrile 2 wt % | 59.3 | 16.8 | 53.5 | 37.5 |
| Example 2 | | | | | |
| Comparative | Succinonitrile 2 wt %, | 70.3 | 16.5 | 75.3 | 29.3 |
| Example 3 | fluoroethylene carbonate 4 wt % | | | | |
| Comparative | Succinonitrile 2 wt %, | 78.5 | 13.3 | 85.5 | 24.5 |
| Example 4 | fluoroethylene carbonate 4 wt %, | | | | |
| | hexane-1,3,6-tricarbonitrile 3 wt % | | | | |
| Comparative | Succinonitrile 2 wt %, | 83.2 | 10.6 | 87.2 | 25.3 |
| Example 5 | fluoroethylene carbonate 4 wt %, | | | | |
| | hexane-1,3,6-tricarbonitrile 3 wt %, | | | | |
| | lithium difluoro(oxalato)borate 0.5 wt % | | | | |
| Comparative | Succinonitrile 2 wt %, | 85.2 | 9.1 | 87.7 | 25.6 |
| Example 6 | fluoroethylene carbonate 4 wt %, | | | | |
| | hexane-1,3,6-tricarbonitrile 3 wt %, | | | | |
| Comparative | Succinonitrile 2 wt %, | 85.0 | 9.2 | 87.4 | 24.5 |
| Example 7 | fluoroethylene carbonate 4 wt %, | | | | |
| | hexane-1,3,6-tricarbonitrile 3 wt %, | | | | |
| Comparative | Succinonitrile 2 wt %, | 84.5 | 9.8 | 86.3 | 24.4 |
| Example 8 | fluoroethylene carbonate 4 wt %, | | | | |
| | hexane-1,3,6-tricarbonitrile 3 wt %, | | | | |
| Comparative | Succinonitrile 2 wt %, | 83.4 | 9.9 | 85.3 | 25.6 |
| Example 9 | fluoroethylene carbonate 4 wt %, | | | | |
| | hexane-1,3,6-tricarbonitrile 3 wt %, | | | | |

From the comparison between Example 1 and Comparative Example 1, it can be seen that the present application improves the high-temperature storage performance and high-temperature capacity retention of batteries and reduces the high-temperature swelling and DCR of the batteries by adding the combination of additives (fluoroethylene carbonate, hexane-1,3,6-tricarbonitrile and pyridine boron trifluoride) in the electrolyte. From the comparison between Examples 2 to 10 and Comparative Examples 4 to 9, it can be seen that the present application achieves equivalent or better high-temperature storage performance and high-temperature capacity retention and also significantly reduces the gas production and impedance of the batteries by adding the combination of additives (succinonitrile, fluoroethylene carbonate, hexane-1,3,6-tricarbonitrile and pyridine boron trifluoride) in the electrolyte and adjusting the ratio of the additives.

From the comparison between Examples 2 to 9 and Examples 11 to 13, it can be seen that by adding the combination of succinonitrile, fluoroethylene carbonate, hexane-1,3,6-tricarbonitrile, pyridine boron trifluoride and other additives to the electrolyte, the capacity retention of the batteries after being charged to 4.55V and subjected to high-temperature storage at 85° C. for 4 h and the capacity retention of the batteries after 200 cycles at 45° C. can be further improved, and the battery swelling (%) of the batteries after being charged to 4.55V and subjected to high-temperature storage at 85° C. for 4 h and the DCR of the batteries at 50% SOC, 2 C for 10 s can be further reduced. It shows that the combination of succinonitrile, fluoroethylene carbonate, hexane-1,3,6-tricarbonitrile, pyridine boron trifluoride and other additives can further improve the high-temperature performance and cycle performance of the batteries, and the safety performance is also further improved.

The above detailed description of the disclosure is intended to enable persons familiar with the art to understand the contents of the disclosure and implement them, instead of limiting the scope of the disclosure. Any equivalent changes or modifications made according to the spirit of the disclosure shall fall within the scope of the disclosure.

What is claimed is:

1. A non-aqueous electrolyte, comprising an organic solvent, an electrolyte lithium salt and additives, wherein the additives comprise pyridine boron trifluoride, fluoroethylene carbonate, and hexane-1,3,6-tricarbonitrile;
the mass percentage content of the pyridine boron trifluoride in the non-aqueous electrolyte is 0.1%-5%;
the mass percentage content of the fluoroethylene carbonate in the non-aqueous electrolyte is 0.1%-10%;
the mass percentage content of the hexane-1,3,6-tricarbonitrile in the non-aqueous electrolyte is 0.1%-5%.

2. The non-aqueous electrolyte according to claim 1, wherein the additives further comprise succinonitrile, and the mass percentage content of the succinonitrile in the non-aqueous electrolyte is 0.1%-5%.

3. The non-aqueous electrolyte according to claim 2, wherein the mass percentage content of the succinonitrile in the non-aqueous electrolyte is 1%-4%.

4. The non-aqueous electrolyte according to claim 1, wherein the mass percentage content of the hexane-1,3,6-tricarbonitrile in the non-aqueous electrolyte is 1%-5%.

5. The non-aqueous electrolyte according to claim 1, wherein the mass percentage content of the hexane-1,3,6-tricarbonitrile in the non-aqueous electrolyte is 1%-4%.

6. The non-aqueous electrolyte according to claim 1, wherein the mass percentage content of the pyridine boron trifluoride in the non-aqueous electrolyte is 0.1%-2%.

7. The non-aqueous electrolyte according to claim 6, wherein the mass percentage content of the pyridine boron trifluoride in the non-aqueous electrolyte is 0.1%-1%.

8. The non-aqueous electrolyte according to claim 1, wherein the mass percentage content of the fluoroethylene carbonate in the non-aqueous electrolyte is 1%10%.

9. The non-aqueous electrolyte according to claim 1, wherein the mass percentage content of the fluoroethylene carbonate in the non-aqueous electrolyte is 2%-8%.

10. The non-aqueous electrolyte according to claim 1, further comprising other additives, wherein the other additives comprise one or more of vinyl ethylene carbonate, tris(trimethylsilyl)borate, tris(trimethylsilyl)phosphate, adiponitrile, 1,2-bis(2-cyanoethoxy)ethane, 1,4-dicyano-2-butene, 1,2,3-tris(2-cyanoethoxy)propane, lithium tetrafluoroborate, and sebaconitrile, and the mass percentage content of each of the other additives in the non-aqueous electrolyte is 0.1%-5%.

11. The non-aqueous electrolyte according to claim 1, not comprising lithium difluoro(oxalato)borate; and/or
not comprising sulfur-containing compounds.

12. The non-aqueous electrolyte according to claim 1, wherein the organic solvent is a mixture of a cyclic ester and a chain ester, and the cyclic ester comprises one or more of γ-butyrolactone, ethylene carbonate, and propylene carbonate. The chain ester includes one or more of dimethyl carbonate, ethyl methyl carbonate, diethyl carbonate, methylpropyl carbonate, methyl propionate, ethyl propionate, propyl propionate, methyl acetate, ethyl acetate, propyl acetate, methyl butyrate, ethyl butyrate, propyl butyrate, methyl fluoropropionate, ethyl fluoropropionate, and ethyl fluoroacetate.

13. The non-aqueous electrolyte according to claim 1, wherein the lithium salt comprises one or more of lithium hexafluorophosphate, lithium hexafluoroarsenate, anhydrous lithium n perchlorate, lithium bis(trifluoromethylsulfonyl)imide, lithium difluorophosphate, lithium trifluoromethylsulfonate, and lithium bis(fluorosulfonyl)imide, and the concentration of the lithium salt is 0.8-3 mol/L.

14. A lithium battery, comprising a cathode, an anode and an electrolyte, wherein the electrolyte comprises the non-aqueous electrolyte according to claim 1.

15. The lithium battery according to claim 14, wherein the lithium battery is a lithium cobalt oxide graphite battery; and/or, the charge cut-off voltage of the lithium battery is higher than 4.4V.
